(19) United States
(12) Patent Application Publication
(10) Pub. No.: US 2026/0217071 A1
(43) Pub. Date: Jul. 30, 2026

(54) MULTI-USE TRAILER HITCH

(71) Applicants: David Todd Haynie, McLoud, OK (US); David Thomas Haynie, McLoud, OK (US)

(72) Inventors: David Thomas Haynie, McLoud, OK (US); David Todd Haynie, McLoud, OK (US)

(21) Appl. No.: 19/456,142

(22) Filed: Jan. 22, 2026

Related U.S. Application Data
(60) Provisional application No. 63/750,424, filed on Jan. 28, 2025.

(51) Int. Cl. B60D 1/07; B60D 1/04; B60D 1/06

(52) U.S. Cl. CPC B60D 1/07; B60D 1/04; B60D 1/06

(57) ABSTRACT

A multi-use trailer hitch assembly for mounting to a towing vehicle. The assembly includes a bracket having a front surface and a top surface joined in an L-shaped configuration. The bracket comprises a plurality of mounting holes for securing the bracket to a vehicle frame, a gooseneck opening formed in the top surface for receiving a gooseneck ball hitch, and a receiver opening formed in the front surface for receiving a receiver hitch insert. A pintle hitch mounting plate is secured to the front surface, and the top surface may be configured to support a fifth-wheel hitch. The bracket may further include air line attachment points, electrical connector openings, and safety chain attachment points. The arrangement enables the towing vehicle to accommodate gooseneck, fifth-wheel, pintle, and receiver trailer hitches without removal or replacement of the bracket.

### SUMMARY

The present invention is directed to a hitch assembly. The hitch assembly comprises an L-shaped bracket having a top surface and a front surface such that the bracket connectable to a truck. The hitch assembly further comprises a receiver hitch disposed through the front surface, a gooseneck ball hitch mounted to the top surface and a pintle hitch attached to the front surface. The hitch assembly is configured to support connection to at least one of the receiver hitch, gooseneck ball hitch, and pintle hitch without disconnecting the L-shaped bracket from the truck.

### BRIEF DESCRIPTION OF THE DRAWINGS

FIG. 1 is a rear plan view of a multi-use trailer hitch bracket for use in connecting a truck to a trailer.

FIG. 2 is a top view of the bracket shown in FIG. 1.

FIG. 3 is a right side view thereof.

FIG. 4 is left side view thereof.

FIG. 5 is a bottom view thereof, with the rear of the bracket at the bottom of the page.

FIG. 6 is a front view thereof, showing a reverse side of the rear view of FIG. 1.

FIG. 7 is a right front bottom perspective view thereof.

FIG. 8 is a left front bottom perspective view thereof.

FIG. 9 is a left front top perspective view thereof.

FIG. 10 is a right front top perspective view thereof.

FIG. 11 is a photograph of the bracket of FIGS. 1-12 being held by chains to the back of a truck having a fifth-wheel hitch supported thereon.

### DETAILED DESCRIPTION

Trailers are commonly used to transport loads from one location to another. A number of trailer types currently exist, such as, but not limited to: flatbed, gooseneck, camper/RV, and semi-trailers. Regardless of what type of trailer is used, every trailer must be connected to a towing vehicle - usually a truck. When connecting to a towing vehicle, or truck, a trailer must join its attachment point to a trailer hitch located on the truck.

While a variety of trailer hitches exist, there are four common types: gooseneck, fifth-wheel, pintle, and receiver. These four types of trailer hitches are distinct, in that each hitch only connects to a specific type of attachment point.

Because each trailer hitch type is only adapted for use with its corresponding type of attachment point, it is impossible to use a single trailer hitch with more than one type of attachment point without significant modification. For example, a truck fitted with a pintle hitch cannot tow a trailer configured with a fifth-wheel attachment point. Trucks can be modified from one trailer hitch type to another, but doing so sacrifices significant time and effort.

Thus, if an operator wants, or needs, to use multiple types of trailer hitches, they usually have multiple trucks, with each truck having a unique trailer hitch. Regardless of whether an operator chooses to use multiple trucks, or change out trailer hitches on a single truck, significant amounts of time and money are sacrificed. Thus, there is a current need in the industry for a way to simultaneously utilize all four traditional trailer hitch types on a single towing vehicle, or truck.

The present disclosure addresses these issues by providing a multi-use trailer hitch bracket 10. The bracket 10 allows one truck, or towing vehicle, to be simultaneously configured for use with a gooseneck, fifth-wheel, pintle, or receiver trailer hitch. Because the bracket 10 allows for the use of all four major trailer hitch types, a single towing vehicle may use a variety of trailers without the need to remove or replace its hitch. This allows for significant reduction in time and money spent by trailer operators. Instead of buying multiple towing vehicles that are each adapted with a specific trailer hitch, or laboring to switch out trailer hitches on a vehicle, an operator may possess a single truck ready for use with a gooseneck, fifth-wheel, pintle, or receiver trailer hitch.

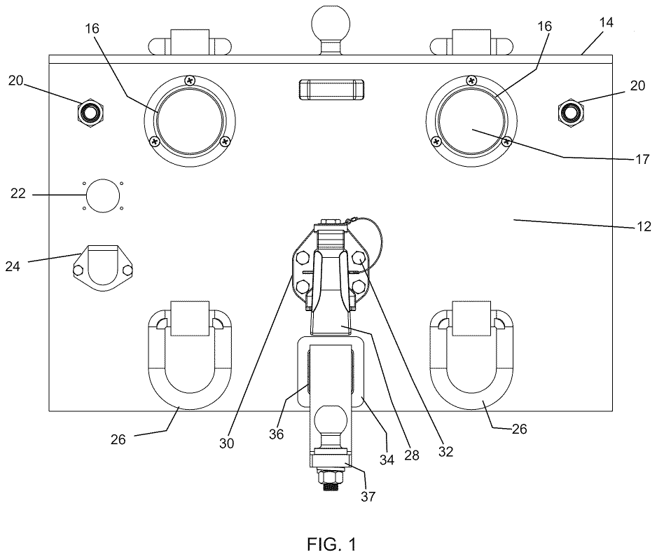

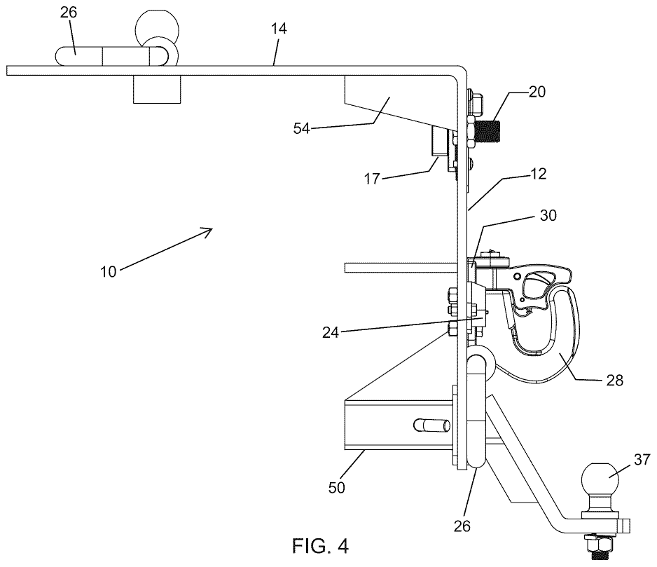

Turning now to the figures, FIGS. 1-4 show various views of the front features of the multi-use trailer hitch bracket 10. It should be understood that the bracket 10 is not shown properly installed within a truck, but instead suspended by chains and temporary mounting points, thus enabling views of all features of the bracket. The bracket 10 is configured to attach to both a towing vehicle, or truck, and a trailer, so that the two are joined together. The bracket 10 comprises a front surface 12 and a top surface 14. The surfaces 12, 14 join together in the shape of an L. The front surface 12 is configured to face a horizontal direction, away from the towing vehicle, while the top surface 14 is configured to face an upper direction, generally towards the sky. Both surfaces 12, 14 are generally flat, with the exception of the features described herein.

Continuing with FIGS. 1-4, the front surface 12 comprises a plurality of light openings 16. The light openings 16 are configured to receive light fixtures 17 positioned on the truck, so that the trailer and the rear of the truck are properly illuminated during operation. The bracket 10 currently shows two openings 16 for lights, but as many light openings 16 as desired may be added. As shown, the fixtures 17 are attached within the openings 16.

Near the light openings 16 are air line attachment points 20. These air line attachment points 20 are configured to connect air lines from within the truck to air lines on the trailer. The air line attachment points 20 may be threaded to allow air tubing, or gladhand coupling devices known in the art, to connect air lines from the truck to the trailer, as needed for braking purposes.

Electrical hookup openings 22 may be formed on the front surface 12 as well. These electrical hookup openings 22 may be filled with electrical sockets 24, like the one shown. These sockets 24 are connected to the truck's electrical system and allow power to be transmitted from the truck to the trailer through an electrical connector. As shown in the figures, there may be multiple electrical hookup openings 22 and sockets 24, so that different shapes and sizes of electrical connectors may be utilized.

Safety attachment points 26 are shown on the front and top surfaces 12, 14 of the bracket 10 via welding or other attachment methods. The safety attachment points 26 are secured to the bracket 10, and provide a tethering point for safety chains from the trailer.

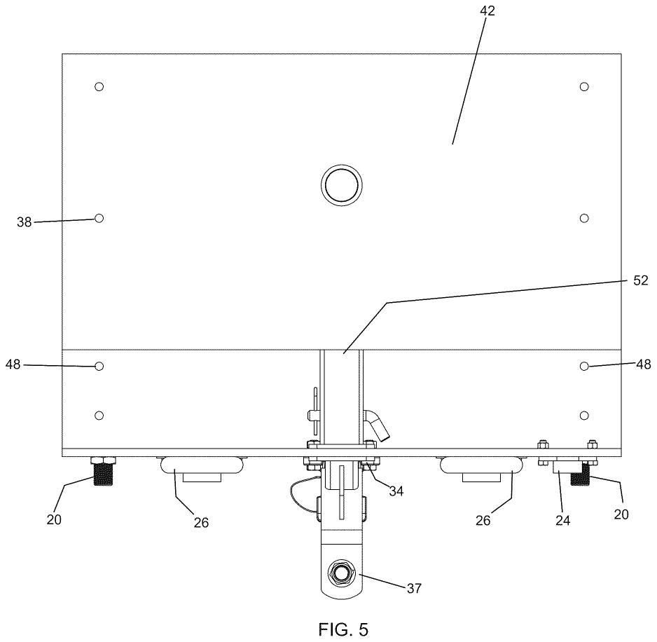

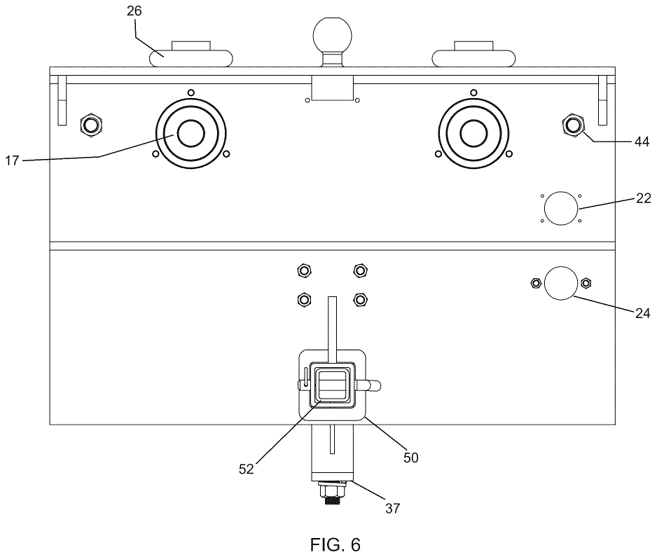

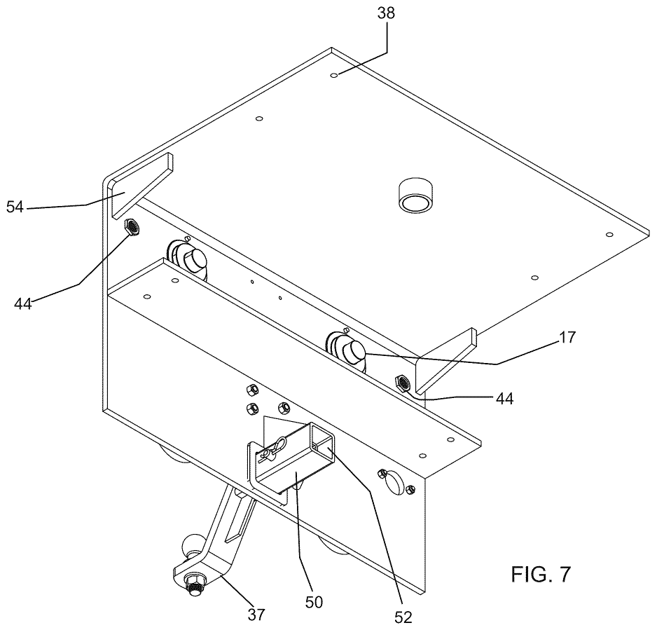

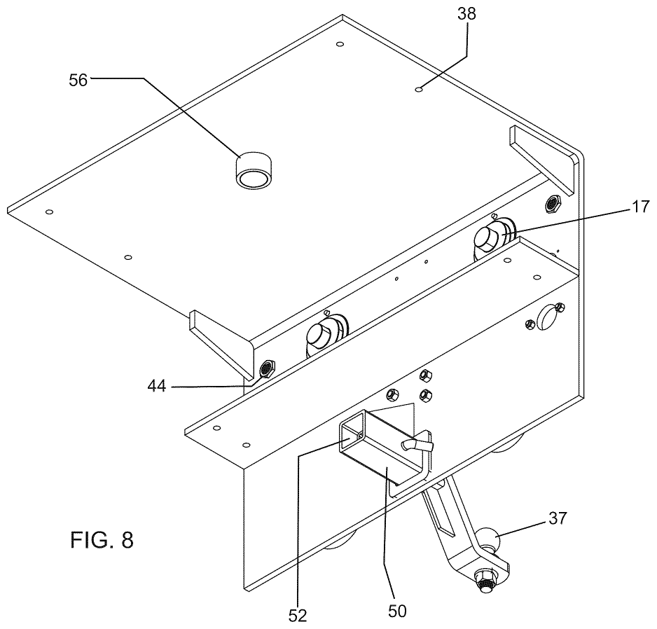

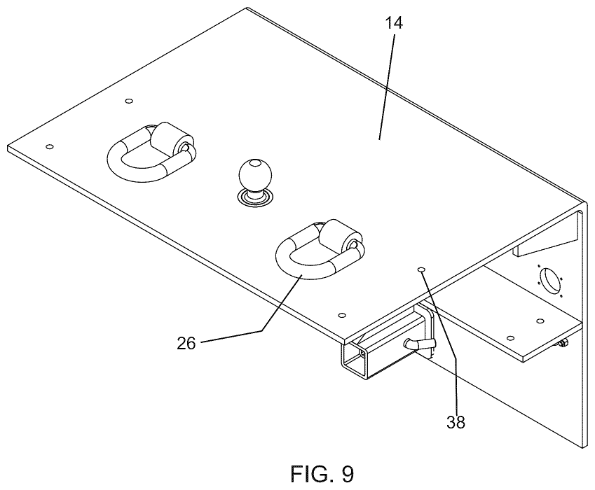

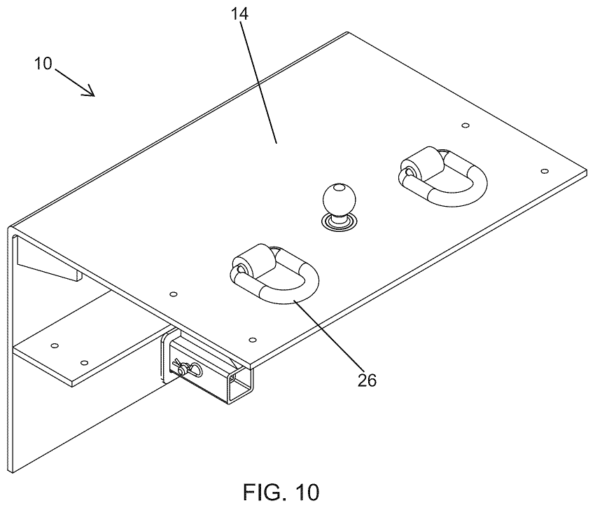

A pintle hitch 28 is shown mounted to a pintle mounting plate 30. The pintle hitch 28 is configured for connection with a pintle trailer. The mounting plate 30 is fastened to the front surface 12 of the bracket 10 using bolts, or studs 32. The plate 30 may also be welded to the front surface 12, to provide additional strength. Below the pintle hitch 28 is a receiver 34. The receiver 34 comprises an opening 36 that is configured to receive a hitch insert, like the ball hitch insert 37 shown in FIGS. 1-10. The receiver 34 along with the hitch insert may be referred to together as a receiver hitch. The receiver hitch is configured to connect with a receiver-hitch trailer.

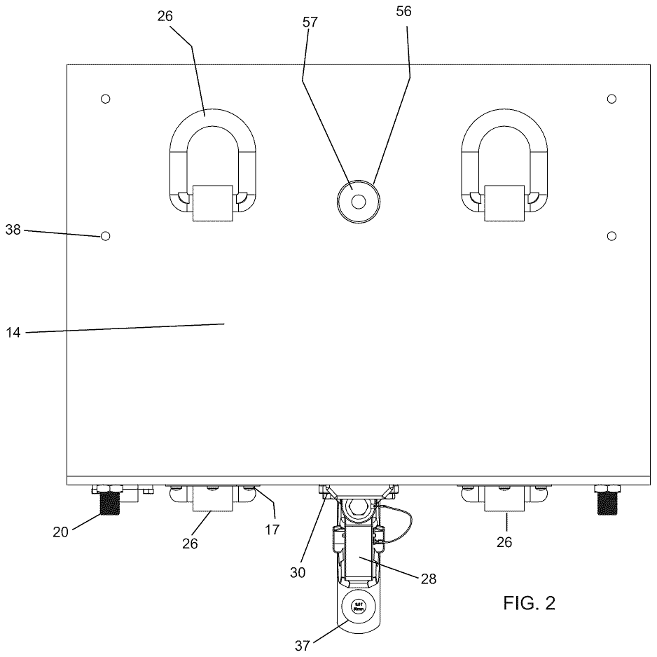

As best shown in FIG. 2, the top surface 14 comprises a plurality of holes 38. These holes 38 are configured to align with mounting holes on the truck. The holes 38 are configured to receive fasteners or threaded bolts/studs that secure the bracket 10 to the truck. A gooseneck hole 56 is also shown on the top surface 14. The gooseneck hole 56 allows for a gooseneck ball hitch 57 to project from the top surface 14 of the bracket 10 and secure the bracket 10 to a gooseneck trailer.

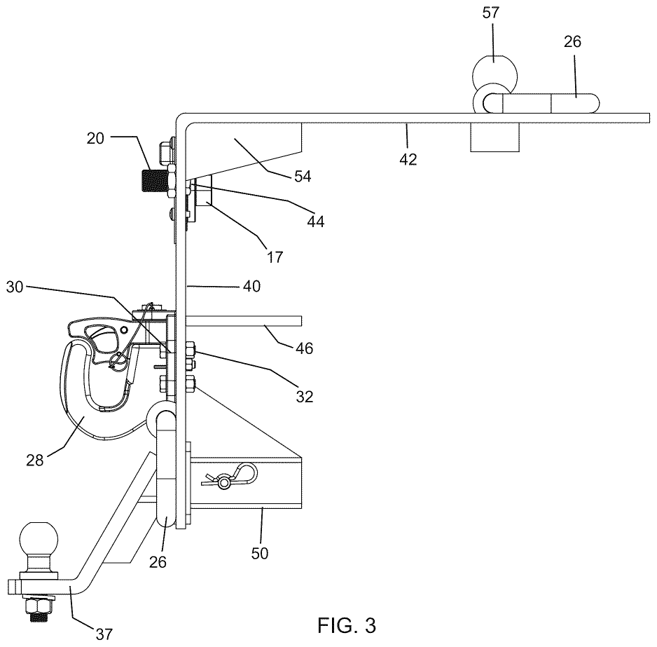

Turning now to FIGS. 3-6, additional features of the bracket 10 are shown. Inner surface 40 is on the opposite side of the same plate as the front surface 12, and inner surface 42 is on the opposite side of the same plate as the top surface 14. A plate 46 extends from the inner surface 40. When the bracket 10 is installed within the truck, portions of the bracket 10, such as the plate 46, are hidden from view.

Rear air line attachment points 44 extend from inner surface 40 (the rear of the front surface 12), allowing air to be connected from the truck to the trailer. These rear line attachment points 44 are exactly the same as air line attachment points 20, and both points 44, 20 are threaded and secured to the bracket 10 by weld, or other air-tight methods.

Near the middle of the inner surface 40 is an attachment plate 46. This attachment plate 46 extends from the inner surface 40, and is configured to secure the bracket 10 between the frame of a truck. The attachment plate 46 may be welded onto the bracket 10, or formed integrally thereon. As mentioned herein, the plate 46 is hidden from view when the bracket 10 is properly installed on the truck. The attachment plate 46 is configured to fit tightly between two frames of the truck, thus further adding to the strength of the design. The attachment plate 46 comprises mounting holes 48. The mounting holes 48 are configured to align with holes on the truck's frame, and receive fasteners or threaded bolts/studs, thus securing the attachment plate 46 to the truck's frame.

The receiver hitch 34 collaborates with a receiver hitch collar 50 extending from the inner surface 40. The receiver hitch collar 50 is configured to receive the hitch insert, as described above. The receiver hitch collar 50 comprises a passage 52 that is configured to receive a rod. The rod passes through both the passage 52 of the receiver hitch collar 50, as well as a passage within the hitch insert, thus securing the hitch insert to the bracket 10. The receiver hitch collar 50 may be welded onto the inner surface 40, attached by other means, or formed integrally with the rest of the bracket 10.

Lateral support plates 54 connect the inner surfaces 40, 42 to one another, and provide structural strength to the bracket 10. The plates 54 are configured to sit flush with the frame of the truck when the bracket 10 is secured thereto, thus allowing the bracket 10 to resist movement during operation. The shape of the plates 54 may be altered as needed to fit with the frame of the truck.

As described herein, the bracket 10 provides added benefits in that it enables gooseneck, fifth-wheel, pintle, and receiver trailer hitches to be present on the same truck at the same time. The pintle hitch 28 is shown attached, as is the receiver 34 for a receiver hitch. A gooseneck ball hitch 57 may be installed within the bracket 10 through the gooseneck hole 56 as well, thus allowing a gooseneck trailer to attach to the bracket 10.

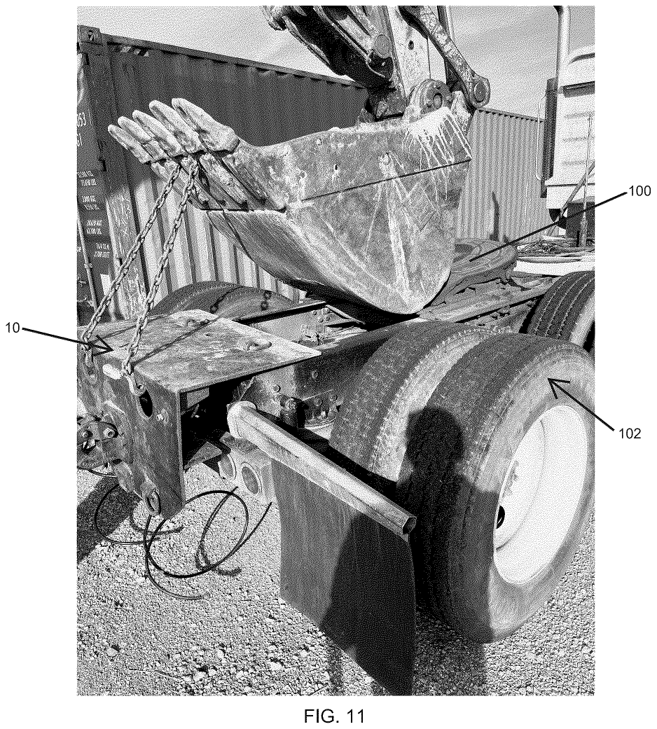

With reference to FIG. 11, a fifth-wheel hitch may be attached to the top surface 14 of the bracket 10. The fifth-wheel hitch 100 may be secured to the top surface 14 by tightening bolts or fasteners through holes formed in the top surface 14, such as holes 38 or similar. Once attached, the fifth-wheel hitch 100 is configured for connection with a fifth-wheel trailer. Alternatively, as shown in FIG. 11, a fifth-wheel hitch 100 may be included on a truck 102 or trailer, with the bracket 10 attached thereto to provide the other connection apparatus.

Thus, the present disclosure is capable of operating with gooseneck, fifth-wheel, pintle, and receiver trailer hitches. The combination of these four traditional trailer hitch systems allows operators to use one vehicle or truck to pull a variety of different types of trailers.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A multi-use trailer hitch assembly for mounting to a towing vehicle, comprising:
a bracket comprising a front surface and a top surface joined in an L-shaped configuration, wherein:
a plurality of mounting holes are formed in the top surface for securing the bracket to a frame of the towing vehicle;
a gooseneck opening is formed in the top surface configured to receive a gooseneck ball hitch;
a receiver opening is formed in the front surface configured to receive a receiver hitch insert; and
a pintle hitch mounting plate secured to the front surface.

2. The apparatus of claim 1, in which the hitch assembly further comprises:
a plurality of air line attachment points;
a plurality of openings, each of the openings configured to receive electrical sockets;
a plurality of safety attachment points disposed on the front surface; and
a plurality of light openings, each of the light openings configured to receive light fixtures.

3. The apparatus of claim 2, in which the hitch assembly further comprises:
a plurality of second safety attachment points, wherein the plurality of second safety attachment points are on the top surface.

4. The apparatus of claim 1, in which the hitch assembly further comprises a fifth-wheel connection.

5. The apparatus of claim 1, wherein the top surface further comprises a plurality of fifth-wheel mounting holes configured to receive fasteners for securing a fifth-wheel hitch to the bracket.

6. The apparatus of claim 1, in which an inner surface is formed on the bracket opposite the front surface, wherein the receiver opening extends through the bracket from the front surface to the inner surface, and further comprising a receiver hitch collar extending from the inner surface of the bracket, the collar having a passage configured to receive the receiver hitch insert.

7. The apparatus of claim 6, further comprising an attachment plate extending from the inner surface of the bracket, the attachment plate configured to fit between frame rails of the towing vehicle and having mounting holes for receiving fasteners.

8. The apparatus of claim 1, further comprising a plurality of lateral support plates connecting the inner surface of the bracket to provide structural rigidity.

9. The apparatus of claim 1, wherein the gooseneck opening is positioned along a longitudinal centerline of the top surface to align with a frame of the towing vehicle.

10. A hitch assembly comprising:
an L-shaped bracket having a top surface and a front surface, the bracket connectable to a truck;
a receiver hitch disposed through the front surface;
a gooseneck ball hitch mounted to the top surface; and
a pintle hitch attached to the front surface;
wherein the hitch assembly is configured to support connection to at least one of the receiver hitch, gooseneck ball hitch, and pintle hitch without disconnecting the L-shaped bracket from the truck.

11. The hitch assembly of claim 10, in which a tow ball is secured to the receiver hitch.

12. A method of using the hitch assembly of claim 11, comprising:
connecting a first selected one of the tow ball, the gooseneck ball hitch, and the pintle hitch to a first trailer;
pulling the first trailer using the hitch assembly; and
thereafter, disconnecting the first trailer from the first selected one of the tow ball, gooseneck ball hitch, and pintle hitch; and
thereafter, connecting a second trailer to a second selected one of the tow ball, gooseneck ball hitch, and pintle hitch.

13. The method of claim 12 in which the first selected one and the second selected one of the tow ball, gooseneck ball hitch, and pintle hitch are distinct.

14. The hitch assembly of claim 10, further comprising a fifth-wheel connection.

15. The hitch assembly of claim 10, further comprising at least one electrical connection port.

16. The hitch assembly of claim 10, further comprising at least one light fixture opening.

17. The hitch assembly of claim 10, in which a first safety connection is disposed on the front surface and a second safety connection is disposed on the top surface.

18. A hitch assembly comprising:
an L-shaped bracket having a top surface and a front surface, the bracket connectable to a truck; and
a plurality of hitch components disposed on the L-shaped bracket, the plurality of hitch components comprising a least two of:
a receiver hitch disposed through the front surface;
a gooseneck ball hitch mounted to the top surface; and
a pintle hitch attached to the front surface; and
a fifth-wheel connection;
wherein the hitch assembly is configured to support connection to a first one of the two hitch components and a second one of the two hitch components without disconnecting the L-shaped bracket from the truck.
